(19) United States
(12) Patent Application Publication
(10) Pub. No.: US 2012/0175487 A1
(43) Pub. Date: Jul. 12, 2012

(54) MUSIC STAND DEVICE

(75) Inventor: YUTAKA GOTO, SHIZUOKA (JP)

(73) Assignee: ROLAND CORPORATION, SHIZUOKA (JP)

(21) Appl. No.: 13/343,717

(22) Filed: Jan. 5, 2012

(30) Foreign Application Priority Data
Jan. 12, 2011 (JP) 2011-003626

(51) Int. Cl. G10G 7/00

(52) U.S. Cl. 248/447

(57) ABSTRACT

A music stand device is disclosed. A score panel (SP) is aligned to a top plate (TP) when it is laid down. Position accuracy of the SP relative to the TP is enhanced. An accommodating member and a guide member are installed to a lower surface of the TP. When another end of a supporting member is rotatably connected to a bottom surface of the accommodating member, it is disposed at a position lower than the lower surface of the TP. A rectangular body-side guide slot is disposed on the lower surface of the TP. A guiding-side guide slot is disposed on the guide member. The two slots are disposed at a position lower than an upper surface of the TP. When a shaft-like member slides in the two slots to lay down the SP, the SP is disposed in an opening of the TP to align with the TP.

### CROSS-REFERENCE TO RELATED APPLICATION

This application claims the priority benefit of Japan application serial no. 2011-003626, filed on Jan. 12, 2011. The entirety of the above-mentioned patent application is hereby incorporated by reference herein and made a part of this specification.

### BACKGROUND OF THE INVENTION

1. Field of the Invention

The invention relates to a music stand device. Particularly, the invention relates to a music stand device, in which a score panel is aligned to a top plate when the score panel is laid down and the position accuracy of the score panel relative to the top plate is enhanced.

2. Description of Related Art

Patent document 1 discloses a conventional music stand device. In the music stand device 100 disclosed by the Patent document 1, a score panel 31 is configured in an upright position by using a supporting arm 33. One end 33a of the supporting arm 33 is rotatably connected to a middle portion at a lower surface of the score panel 31, and another end 33b of the supporting arm 33 is also rotatably connected to a installation base 32 (a top plate). Moreover, a recess portion 32a is formed on an upper surface of the installation base 32, and the recess portion 32a is approximately a square cavity, and a music stand collection portion 50 is inlaid to the recess portion 32a.

A guide regulation portion 51 penetrates through a bottom surface of the music stand collection portion 50, and a guide portion 40 is inserted and fixed to the guide regulation portion 51 from a downside, and a guide path 43 used for guiding shaft members 31a installed at two sides of the score panel 31 is formed on the guide portion 40. Therefore, by sliding the shaft member 31a of the score panel 31 in the guide path 43 on the guide portion 40, the score panel 31 is configured in an upright position or laid down relative to the installation base 32 by a specific angle.

### TECHNICAL DOCUMENT OF PRIOR ART

### Patent Document

[Patent document 1] Japan Patent Publication No. 2005-181905 (FIG. 1, etc.)

However, in the conventional music stand device, the other end of the supporting arm is connected to an upper surface of the top plate, so that a pivot of the other end (lower side) of the supporting arm is set at a place higher than the upper surface of the top plate. Therefore, even if the score panel is laid down, the score panel is still located at the place higher than the upper surface of the top plate, so that a following problem is encountered, i.e. the score panel cannot be aligned to the top plate when the score panel is laid down.

Moreover, since the guide portion is set in the music stand collection portion, even if the guide portion is fixed to a specific position relative to the music stand collection portion, once an inlaid position of the music stand collection portion relative to the top plate is deviated from a specific position, a position at which the guide portion is configured relative to the top plate is also deviated from the specific position. Therefore, a following problem is encountered, i.e. the position at which the score panel is configured relative to the top plate has poor accuracy.

### SUMMARY OF THE INVENTION

The invention is directed to a music stand device, in which a score panel is aligned to a top plate when the score panel is laid down and the position accuracy of the score panel relative to the top plate is enhanced.

According to the music stand device of a first technical solution, a plate-like score panel is rotatably connected to a supporting member of the score panel through one end, and is configured in an upright position or laid down relative to a plate-like top plate.

Herein, a top plate holding member is installed on the top plate in a manner of blocking an opening penetrating through the top plate, and another end of the supporting member is rotatably connected to a bottom surface of the top plate holding member. On at least one of the opposite side surfaces of the score panel, shaft-like members are disposed in protrusion at a position that becomes a lower part of the score panel when the score panel is configured in an upright position. The shaft-like member is engaged to an upright slot of the top plate holding member due to a deadweight of the score panel when the score panel is configured in an upright position, and when the score panel is changed from an upright state to a lay-down state or otherwise, the shaft-like member moves in a guide slot recessed in any one of the top plate holding member and the top plate.

In this situation, a bottom surface of the top plate holding member is disposed at a position lower than the upper surface of the top plate, and the guide slot recessed in any one of the top plate holding member and the top plate is continuous with the upright slot recessed in the top plate holding member, and is disposed at a position lower than the upper surface of the top plate. Therefore, the other end of the supporting member is disposed at a position lower than the upper surface of the top plate. Further, when the shaft-like member moves in the guide slot to lay down the score panel, the score panel is disposed in the opening of the top plate and is aligned to the top plate. Therefore, an effect of aligning the score panel to the top plate in the lay-down state of the score panel is achieved.

Moreover, the shaft-like member disposed in protrusion on the score panel is supported by the top plate itself or the top plate holding member installed on the top plate. Therefore, the position at which the score panel is configured relative to the top plate is specified, and the position accuracy of the score panel relative to the top plate is enhanced.

According to the music stand device of a second technical solution, asides from the effect of the music stand device of the first technical solution, the top plate holding member has a guide member disposed in a recess of the upright slot and an accommodating member blocking the opening of the top plate and rotatably connected to the other end of the supporting member through a bottom surface, where the guide member and the accommodating member are separately formed. Therefore, the guide member can be disposed at a place apart from the accommodating member by a specific distance. Therefore, when the score panel is configured in an upright position, the top plate covers the guide member, so that an effect of enhancing the design property of the music stand device is achieved.

According to the music stand device of a third technical solution, asides from the effect of the music stand device of the first technical solution or the second technical solution, when the score panel is laid down, the top plate holding member supports the shaft-like member. In this way, the score panel is positioned relative to the top plate along an up and down direction. Therefore, a following effect is achieved, i.e. the position accuracy of the score panel relative to the top plate along the up and down direction can be enhanced.

According to the music stand device of a fourth technical solution, asides from the effect of the music stand device of the second technical solution, when the score panel is laid down, the guide member supports the shaft-like member. In this way, the score panel is positioned relative to the top plate along an up and down direction. Therefore, a following effect is achieved, i.e. the position accuracy of the score panel relative to the top plate along the up and down direction can be enhanced.

According to the music stand device of a fifth technical solution, asides from the effect of the music stand device of the second technical solution or the fourth technical solution, the guide member contains resin, and at least a part of the guide slot is disposed in a recess on the top plate containing wood. Therefore, the wood has a low processing cost compared to that of the resin, so that by disposing at least a part of the guide slot on the top plate, a following effect is achieved, i.e. compared to a situation of processing all of the guide slots on the guide member, the processing cost of the guide slot can be reduced.

According to the music stand device of a sixth technical solution, asides from the effect of the music stand device of any one of the first technical solution to the fifth technical solution, when the score panel is laid down, a specific gap is formed between an opening surface of the top plate and a front surface of the score panel, so that a following effect is achieved, i.e. even if the score panel is laid down while a finger contacts the opening surface of the top plate or the front surface of the score panel, the finger is prevented from getting caught between the opening surface of the top plate and the front surface of the score panel.

According to the music stand device of a seventh technical solution, asides from the effect of the music stand device of the sixth technical solution, the opening surface of the top plate is disposed in front of the score panel when viewing from a player side as the score panel is configured in an upright position. Accordingly, by inclining the opening surface of the top plate in a manner that a distance between the opening surface and a front surface of the score panel is narrowed along a direction from the upper surface to the lower surface of the top plate, a score surface leaning against the score panel is easily viewed.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1(a) is a three-dimensional view of a keyboard device having a music stand device according to an embodiment of the invention.

FIG. 1(b) is a side view of the music stand device of FIG. 1(a) viewing from a direction of an arrow Ib.

FIG. 2(a) is a top view of a music stand device.

FIG. 2(b) is a bottom view of a music stand device.

FIG. 3 is a partial enlarged cross-sectional view of the music stand device of FIG. 2(a) along the line.

FIG. 4 is an enlarged cross-sectional view of the music stand device of FIG. 2(a) along the IV-IV line.

FIG. 5 is an enlarged cross-sectional view of the music stand device of FIG. 4.

FIG. 6(a) is a top view of a guide member.

FIG. 6(b) is a bottom view of the guide member.

FIG. 6(c) is a side view of the guide member of FIG. 6(b) viewing from a direction of an arrow VIc.

FIG. 6(d) is a cross-sectional view of the guide member of FIG. 6(c) along the VId-VId line.

FIG. 7 is an exploded view of a music stand device exploded into an accommodating member, a supporting member, a score panel and a score surface end portion.

FIG. 8 is an exploded view of a music stand device exploded into an accommodating member, a guide member and a top plate.

FIG. 9 is a three-dimensional view of a music stand device with an accommodating member and a guide member fixed to a top plate.

### DETAILED DESCRIPTION OF DISCLOSED EMBODIMENTS

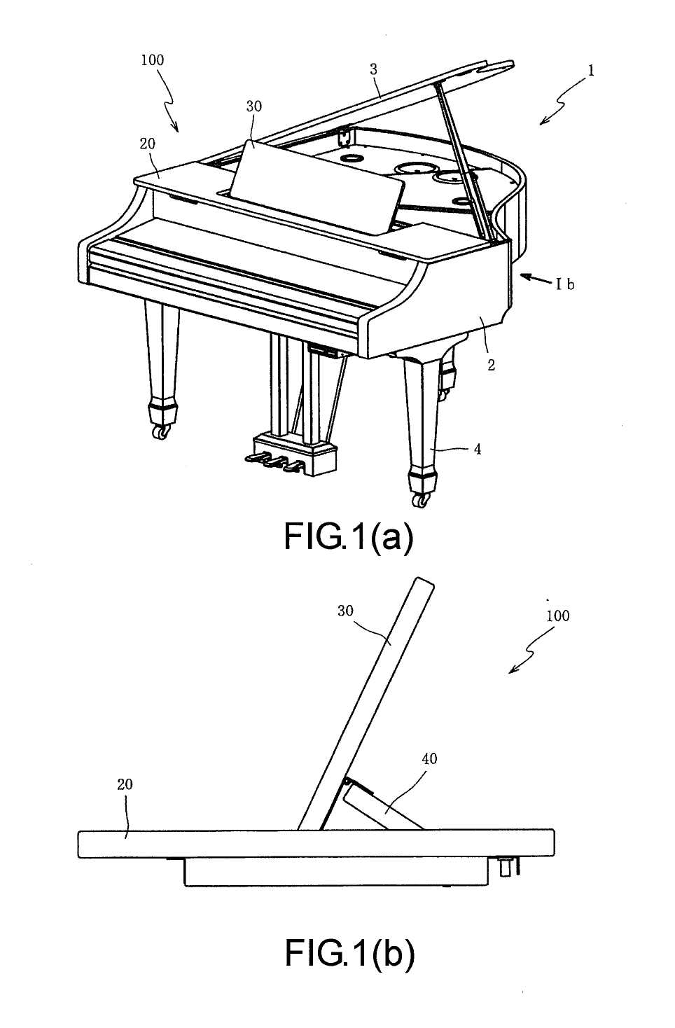

An exemplary embodiment of the invention is described below with reference to the figures. Firstly, a schematic structure of a keyboard device 1 having a music stand device 100 of the invention is described with reference to FIG. 1(a) and FIG. 1(b). FIG. 1(a) is a three-dimensional view of the keyboard device 1 having the music stand device 100 according to an embodiment of the invention, which illustrates an upright state of the score panel 30 when a large top cover 3 is opened. And, FIG. 1(b) is a side view of the music stand device 100 of FIG. 1(a) viewing from a direction of the arrow 1b, which illustrates the upright state of the score panel 30. Moreover, in FIG. 1(b), the illustration of a body 2, which is used for installing a top plate 20, is omitted. In the keyboard device 1 of the specification, a player side (a left side of FIG. 1(b)) is referred to as “front”, and a side of the large top cover 3 (a right side of FIG. 1(b)) is referred to as “back”, and “right” and “left” are determined with reference of a direction of the player observing the music stand device 100.

As shown in FIG. 1(a) and FIG. 1(b), the keyboard device 1 is an electronic piano having an appearance as that of a grand piano, which includes the following parts: three legs 4; the body 2, which is supported by the three legs 4 and accommodates a keyboard (not shown), etc.; the large top cover 3, which is supported by the body 2 and is capable of being opened and closed along an up and down direction (an up and down direction of FIG. 1(a) and FIG. 1(b)); and the music stand device 100, which is disposed in front of the large top cover 3. In the music stand device 100, the score panel 30 may be configured in an upright position on or laid down to the top plate 20 through a supporting member 40.

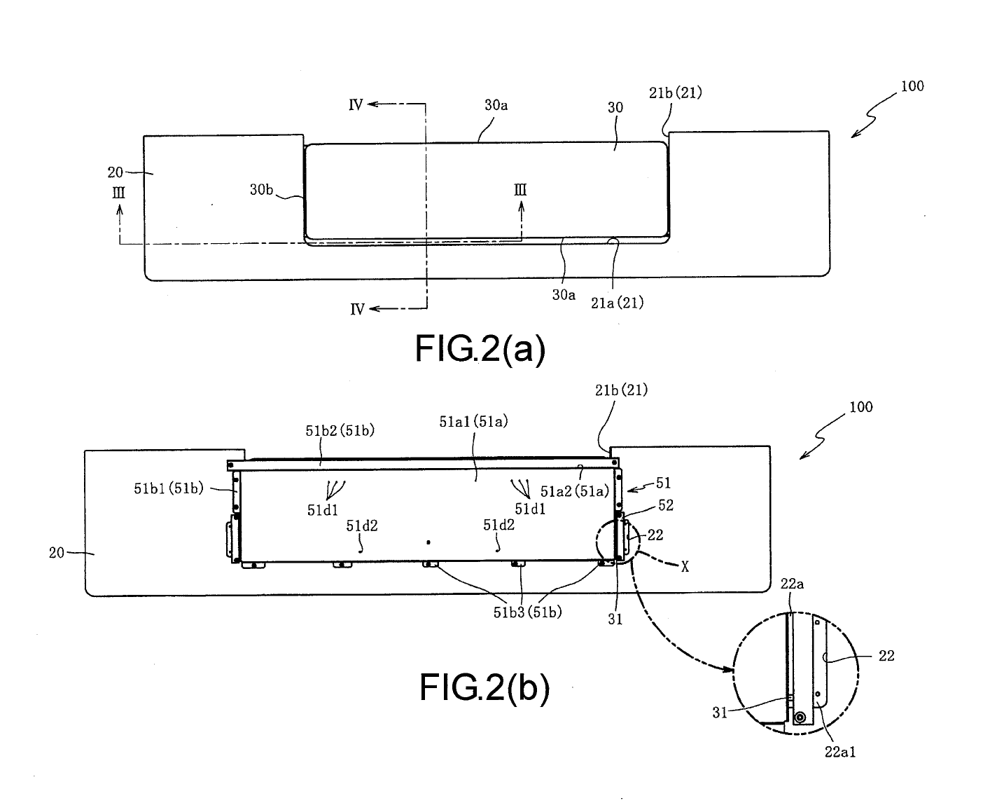

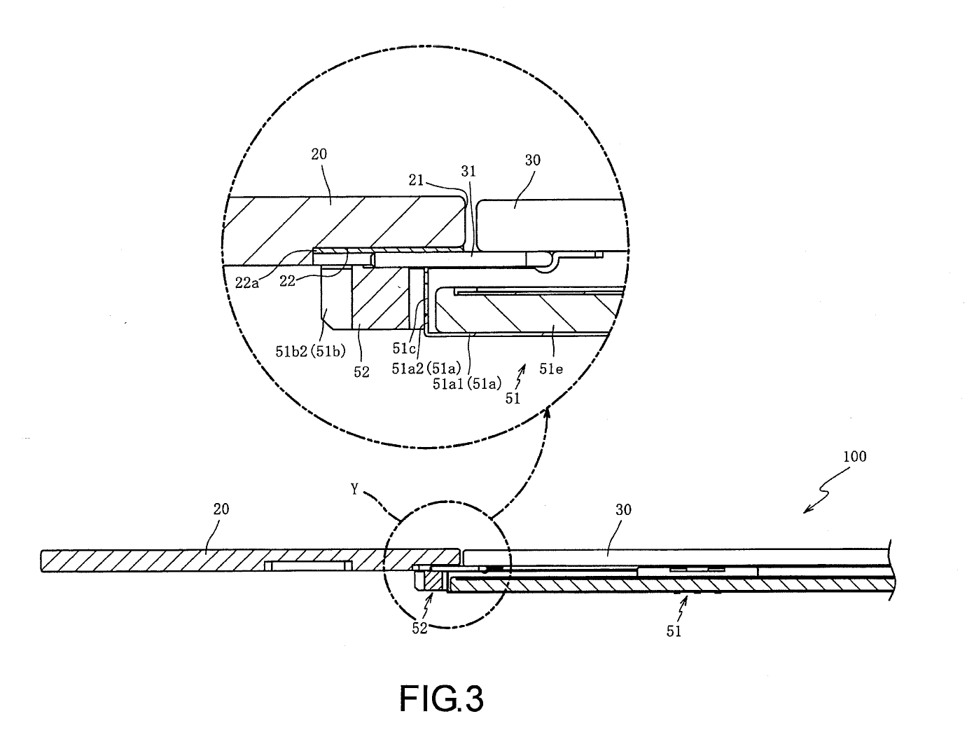

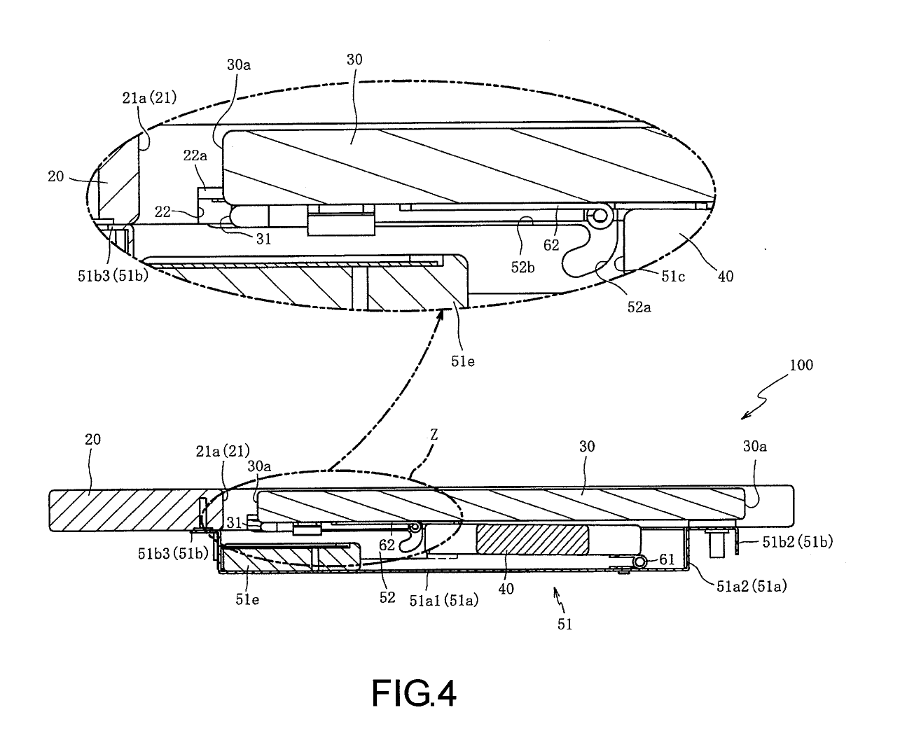

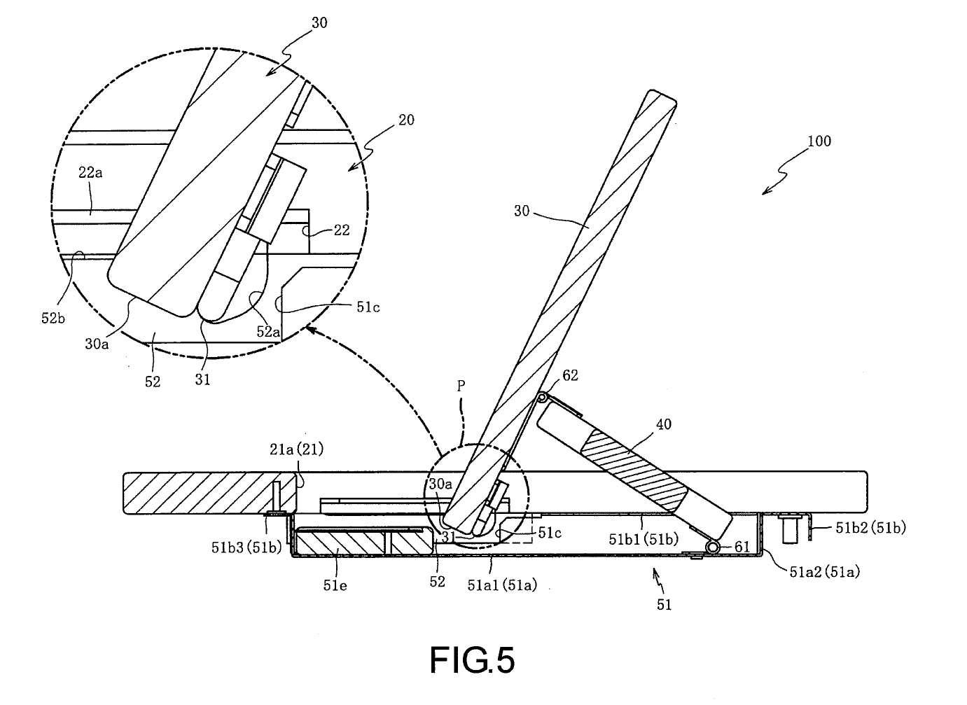

A detailed structure of the music stand device 100 is described below with reference to FIG. 2(a) and FIG. 2(b) to FIGS. 6(a), 6(b), 6(c) and 6(d). FIG. 2(a) is a top view of the music stand device 100. FIG. 2(b) is a bottom view of the music stand device 100. FIG. 3 is a partial enlarged cross-sectional view of the music stand device 100 of FIG. 2(a) along the line. FIG. 4 is an enlarged cross-sectional view of the music stand device 100 of FIG. 2(a) along the IV-IV line, which illustrates a lay-down state of the score panel 30. FIG. 5 is an enlarged cross-sectional view of the music stand device 100 of FIG. 4, which illustrates an upright state of the score panel 30. And, a part X of FIG. 2(a) and FIG. 2(b), a part Y of FIG. 3, a part Z of FIG. 4 and a part P of FIG. 5 are respectively enlarged in FIG. 2(a) and FIG. 2(b) to FIG. 5. Moreover, the top plate 20 is symmetrically formed at the left side and the right side, and only the left part of the top plate 20 is illustrated in FIG. 3.

As shown in FIG. 2(a) and FIG. 2(b) to FIG. 5, the music stand device 100 includes the following parts: the top plate 20, which is disposed in front of the large top cover 3 (referring to FIG. 1(a) and FIG. 1(b)) and is supported by the body 2 (referring to FIG. 1(a) and FIG. 1(b)); the score panel 30, which is configured in an upright position on and laid down to the top plate 20; the supporting member 40, which is used to configure the score panel 30 in an upright position or to lay down the score panel 30 relative to the top plate 20; shaft-like members 31, which are configured on opposite side surfaces of the score panel 30, and are disposed in protrusion at a position of the score panel 30 that becomes a lower part when the score panel 30 is configured in an upright position; an accommodating member 51, which is fixed to a lower surface of the top plate 20; and a guide member 52, which is installed to the lower surface of the top plate 20. The score panel 30 is aligned to the top plate 20 in the lay-down state.

As shown in FIG. 2(a), FIG. 2(b) and FIG. 3, the top plate 20 is formed with a rectangular plate having a length relatively long along a left-right direction (a left-right direction of FIG. 2(a) and FIG. 2(b)), and an opening 21 penetrates through the plate in a direction along the thickness of the plate (a direction vertical to the paper surface of FIG. 2(a) and FIG. 2(b)) at the central portion of the left-right direction and extends to a rear edge (a top edge of FIG. 2(b)) of the top plate 20. Moreover, on the lower surface of the top plate 20, the accommodating member 51 (described later) is installed in a manner of blocking the opening 21. In this way, the score panel 30 is disposed in the opening 21.

The top plate 20 includes the following parts: a front opening surface 21a and a pair of left and right opening surfaces 21b. The front opening surface 21a is an inner side surface for forming the opening 21 of the top plate 20. The front opening surface 21a is disposed separately from the score panel 30 under the upright state of the score panel 30, and is disposed close to the score panel 30 under the lay-down state of the score panel 30. And, the left and right opening surfaces 21b are continuous with two ends of the front opening surface 21a, and are inner side surfaces for forming the opening 21 of the top plate 20. The front opening surface 21a and the pair of left and right opening surfaces 21b include surfaces perpendicular to the upper surface and the lower surface of the top plate 20.

The opening 21 penetrates through the plate along the direction of the thickness of the plate and extends to the rear edge of the top plate 20. In this way, an opened gap is formed at a backside (the top side of FIG. 2(a) and FIG. 2(b)) through the pair of left and right opening surfaces 21b and the front opening surface 21a. Therefore, when the score panel 30 is laid down, a long surface 30a (a surface located at a top side of FIG. 2(a) and FIG. 2(b)) at the backside of the score panel 30 (described later) is not interfered with the top plate 20. Therefore, event if the score panel 30 is laid down while the finger contacts the long surface 30a at the backside of the score panel 30, the top plate 20 and the finger are not interfered. Therefore, the finger is avoided being caught between the score panel 30 and the top plate 20 when the score panel 30 is laid down, and the laying-down of the score panel 30 can be simply performed.

Rectangular body-side guide slots 22 are recessed in the lower surface (a page surface side and a front side of FIG. 2(b)) of the top plate 20 along lower edges of the left and right opening surfaces 21b. The body-side guide slots 22 are slots where the shaft-like members 31 (described later) slide on. And, compared to the guide member 52 (described later), the body-side guide slots 22 have a shorter length along a back and forth direction (an up and down direction of FIG. 2(a) and FIG. 2(b)), and have a length that is longer along a left-right direction (the left-right direction of FIG. 2(a) and FIG. 2(b)), and have a depth along an up and down direction (the direction vertical to the page surface of FIG. 2(a) and FIG. 2(b)) slightly longer than a diameter of the shaft-like member 31 (described later). A plate 22a is adhered on a surface (a surface parallel to the upper surface and the lower surface of the top plate 20) of the body-side guide slot 22, and is fixed thereto through a bolt 22a1 screwed from the side of the body-side guide slot 22 (the side of the lower surface of the top plate 20, the page surface side and the front side of FIG. 2(b)).

Since the plate 22a is disposed between the body-side guide slot 22 and the shaft-like member 31, the plate 22a is prevented from producing noise when the shaft-like member 31 rubs against the wooden body-side guide slot 22. Namely, when the shaft-like member 31 contacts and slides in the body slide slot 22, the shaft-like member 31 rubs against the body slide slot 22 to produce noise. In the present embodiment, by disposing the plate 22a between the body-side guide slot 22 and the shaft-like member 31, a direct contact and sliding between the body-side guide slot 22 and the shaft-like member 31 are prevented, so as to avoid producing the noise.

Moreover, as the length of the body-side guide slot 22 along the left-right direction (the left-right direction of FIG. 2(a) and FIG. 2(b)) is set to be longer than that of the guide member 52, the bolt 22a1 screwed from the lower surface of the top plate 20 is configured at a place more exterior than the guide member 52 (described later) along the left-right direction, and the guide member 52 is observed from the lower surface of the top plate 20. Therefore, as the guide member 52 is fixed, the bolt 22a1 is used to fix the plate 22a.

Namely, viewing from the lower surface of the top plate 20 (the page surface side and the front side of FIG. 2(b)), the bolt 22a1 screwed from the lower surface (b) of the top plate 20 is set to overlap with the guide member 52 (described later) along the up and down direction (the direction vertical to the page surface of FIG. 2(a) and FIG. 2(b)), and the bolt 22a1 is not fixed without disassembling the guide member 52. Comparatively, in the invention, by enlarging the body-side guide slot 22 along the left-right direction, a screwing position of the bolt 22a1 can be disposed toward outside apart from the guide member 52 along the left-right direction. Therefore, the guide member 52 and the bolt 221 are not overlapped along the up and down direction. And, the bolt 22a1 is simply fixed to the body-side guild slot 22 without disassembling the guide member 52, so as to enhance operability. Moreover, since the body-side guide slot 22 is disposed in a recess on the lower surface of the top plate 20, the body-side guide slot 22 is disposed at a position lower than that of the upper surface of the top plate 20.

As shown in FIG. 2(a) and FIG. 2(b) to FIG. 5, the score panel 30 has a plate which has thickness thinner than that of the top plate 20 and has a relatively long length along the left-right direction (the left-right direction of FIG. 2(a) and FIG. 2(b). The score panel 30 has a pair of long surface 30a extending along the left-right direction and a pair of short surface 30b extending along the back and forth direction (the up and down direction of FIG. 2(a) and FIG. 2(b)) to form a rectangular shape. One end of the supporting member 40 is rotatably connected to the lower surface (the lower surface of FIG. 4) of the score panel 30, and the shaft-like members 31 are installed on the lower surface of the score panel 30, and respectively protrude out from the score panel 30 towards the left-right directions (the left-right direction of FIG. 3).

The shaft-like member 31 is a pin sliding in the body-side guide slot 22, and a cross section of the shaft-like member 31 including an axial centre forms a “L” shape. Moreover, the shaft-like member 31 is fixed to the lower surface of the score panel 30 when the score panel 30 is in the lay-down state, and is located adjacent to the long surface 30a (described later) (the surface at the lower side of FIGS. 2(a) and 2(b)) at the front side of the score panel 30. Therefore, a length of the shaft-like member 31 is set to match a following situation, i.e. when the score panel 30 is disposed in the opening 21 that penetrates through the top plate 20, the shaft-like members 31 protruding out from the score panel 30 towards the left-right directions are accommodated in the body-side guide slots 22.

As shown in FIG. 2(a) and FIG. 2(b) and FIG. 3, the guide member 52 and the accommodating member 51 are separately formed. The accommodating member 51 is installed to the lower surface of the top plate 20 in a manner of blocking the opening 21 of the top plate 20, and the guide member 52 is installed to the lower surface of the top plate 20 in a manner of covering the body-side guide slot 22 of the top plate 20.

As shown in FIG. 2(a) and FIG. 2(b) to FIG. 5, the accommodating member 51 is a box-like member used for accommodating the score panel 30 and the supporting member 40 etc. The accommodating member 51 includes the following parts: a body portion 51a, which has a bottom surface 51a1 suitable for rotatably connecting the other end of the supporting member 40, and walls 51a2 are configured in an upright position on the edges of the bottom surface 51a1 to form a box shape; flanges 51b, which extend in parallel to the bottom surface 51a1 of the body portion 51a from upper edges of the walls 51a2 of the body portion 51a respectively; cut portions 51c, which are formed by cutting the walls 51a2 of the body portion 51a along the left-right direction (the direction vertical to the page surface of FIG. 5) respectively; bolt holes 51d1 and 51d2, which penetrate through the bottom surface 51a1 of the body portion 51a; and a score surface end portion 51e, which is fixed to the bottom surface 51a1 of the accommodating member 51. In the bolt hole 51d2, a bolt (not shown) is screwed to fix the score surface end portion 51e to the bottom surface 51a1 of the accommodating member 51.

As shown in FIG. 5, the accommodating member 51 is connected to the score panel 30 through the supporting member 40. Namely, one end of the supporting member 40 is rotatably connected to a middle portion of the lower surface of the score panel 30 through a hinge 62, and the other end of the supporting member 40 is rotatably connected to the accommodating member 51 (the bottom surface 51a1 of the body portion 51a) through a hinge 61. Moreover, the bolt (not shown) used for fixing the hinge 61 to the bottom surface 51a1 of the accommodating member 51 is screwed in the bolt hole 51d1.

Since the body portion 51a of the accommodating member 51 is formed as the box shape, the accommodating member 51 is installed to the lower surface (the lower surface shown in FIG. 4 and FIG. 5) of the top plate 20, and the accommodating member 51 (the bottom surface 51a1 of the body portion 51a) protrudes downwards (the lower side of FIG. 4 and FIG. 5) from the lower surface of the top plate 20. Therefore, by connecting the other end of the supporting member 40 (an end located at a lower side when the score panel 30 is configured in an upright position) to the accommodating member 51 (the bottom surface 51a1 of the body portion 51a), when the score panel 30 is in the upright state, as the accommodating member 51 (the bottom surface 51a1 of the body portion 51a) protrudes downwards from the lower surface of the top plate 20, the other end of the supporting member 40 is located at a place lower than the lower surface of the top plate 20.

The flanges 51b include a pair of side surface flanges 51b1, a back surface flange 51b2 and a plurality of front surface flanges 51b3. The pair of side surface flanges 51b1 is extended from the walls 51a2 at the left and right sides of the body portion 51a. The back surface flange 51b2 is extended from the wall 51a2 at the back side of the body portion 51a. The plurality of front surface flanges 51b3 is extended from the wall 51a2 at the front side of the body portion 51a.

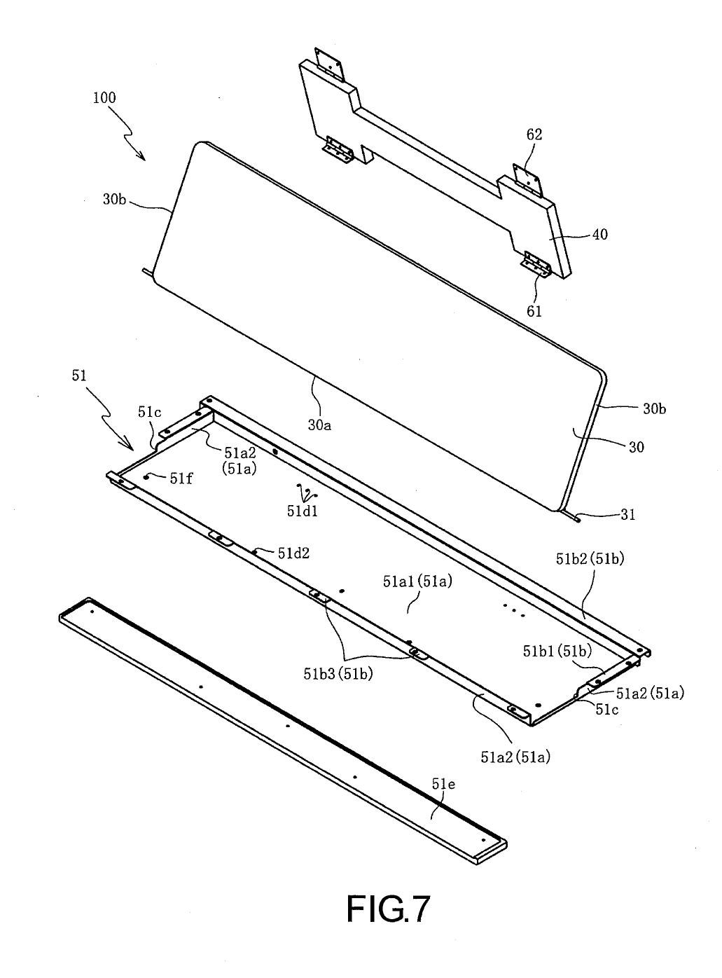

The side surface flanges 51b1 have a length shorter than a length of the walls 51a2 of the left and right sides (the walls 51a2 cut with the cut portions 51c) along a back and forth direction (the left-right direction of FIG. 4) (referring to FIG. 7). Therefore, the guide member 52 can be scaled up as the side surface flanges 51b1 is shortened.

The back surface flange 51b2 is set to have a length longer than a length of the body portion 51a along the left-right direction (the left-right direction of FIG. 2(a) and FIG. 2(b)), and a cross section thereof orthogonal to the bottom surface 51a1 of the body portion 51a and parallel to the walls 51a2 of the left and right sides has a “L” shape, and is fixed to the top plate 20 by crossing the opening 21 of the top plate 20 (in a manner of connecting the pair of the short surfaces 30b opposite to each other and clamping the opening 21 of the score panel 30). Therefore, the rigidity of the top plate 30 is strengthened through the back surface flange 51b2, so as to improve durability of the top plate 20 containing wood.

The front surface flanges 51b3 have a plurality of parts (5 parts) shorter than the back surface flange 51b2. In this way, compared to a situation of forming the front surface flange 51b3 along the left-right direction of the body part 51a through one member, light weight is achieved and cost is reduced.

The cut portions 51c are openings formed by cutting the walls 51a2 at the left and right sides of the body portion 51a. The cut portions 51c are formed to facilitate the shaft-like members 31 protruding out from the score panel 30 to protrude out from the accommodating member 51 (the walls 51a2 at the left and right sides of the body portion 51a). Therefore, when the score panel 30 installed with the shaft-like members 31 is connected to the accommodating member 51 (the bottom surface 51a1 of the body portion 51a) through the supporting member 40, the shaft-like members 31 protrude out from the walls 51a2 at the left and right sides of the body portion 51a through the cut portions 51c. When the accommodating member 51 is fixed to the lower surface of the top plate 20, the shaft-like members 31 are accommodated in the body-side guide slots 22 of the top plate 20.

The score surface end portion 51e is fixed to a front part (the left part of FIG. 4 and FIG. 5) of the accommodating member 51 (the bottom surface 51a1 of the body portion 51a), and includes a plate-like member. The plate-like member has a rectangular shape and has a specific thickness, where a long side thereof has a length approximately the same as the length (along the left-right direction of FIG. 3) of the accommodating member 51. Therefore, the upper surface of the score surface end portion 51e is higher than the bottom surface 51a1 of the body portion 51a by a step.

By aligning the score panel 30 with the top plate 20 under the lay-down state of the score panel 30, even if the lower end of the score panel 30 is lower than the top plate 20 when the score panel 30 is configured in an upright position, a supporting point of the score surface leaning against the score panel 30 is raised, so that the score surface is easily viewed, since the upper surface of the score surface end portion 51e is higher than the bottom surface 51a1 of the body portion 51a by a step.

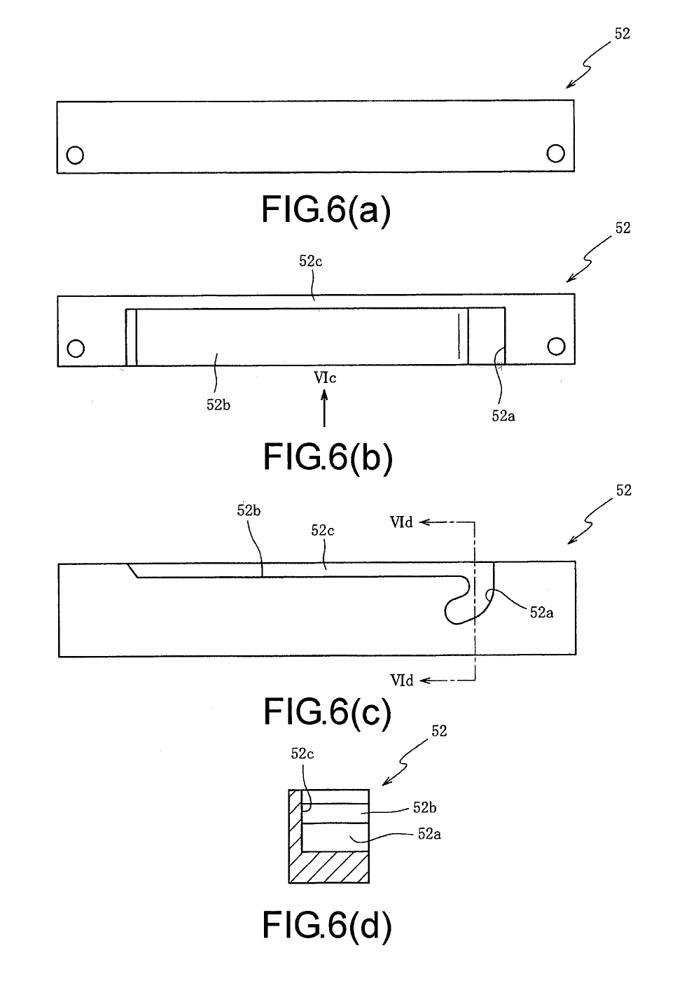

The guide member 52 is illustrated in FIGS. 6(a), 6(b), 6(c) and 6(d). FIG. 6(a) is a top view of the guide member 52. FIG. 6(b) is a bottom view of the guide member 52. FIG. 6(c) is a side view of the guide member 52 of FIG. 6(b) viewing from a direction of an arrow VIc. FIG. 6(d) is a cross-sectional view of the guide member 52 of FIG. 6(c) along a VId-VId line. The guide member 52 is described with reference to FIG. 4 to FIGS. 6(a), 6(b), 6(c) and 6(d).

As shown in FIG. 4 to FIGS. 6(a), 6(b), 6(c) and 6(d), the guide member 52 is made of resin and has a shape of a rectangular cube, which is recessed in a slot, and the slot corresponds to the body-side guide slot 22 of the top plate 20. When the score panel 30 is configured in an upright position or laid down, the shaft-like member 31 is slided on or engaged to the slot. In detail, the guide member 52 is configured with a recess with following parts: an upright slot 52a, which appears to have a shape of “ [symbol] ” viewing from a side view (the page surface side and the front side of FIG. 6(c)); and a linear guiding-side guide slot 52b continuous to the upright slot 52a and extending along a back and forth direction (the left-right direction of FIG. 6(c). Moreover, the guide member 52 has a limit wall 52c. The limit wall 52c is continuous to the guiding-side guide slot 52b and the upright slot 52a, and the limit wall 52c is disposed in an upright configuration along an up and down direction (an up and down direction of FIG. 6(c)) of the guide member 52.

The upright slot 52a is a slot where the shaft-like member 31 is engaged to due to the deadweight of the score panel 30 when the score panel 30 is configured in an upright position. A lower part of the upright slot 52a (a part closest to the bottom surface of the body portion 51a) is disposed lower than the top end of the score surface end portion 51e (the lower side of FIG. 4 and FIG. 5).

The guiding-side guide slot 52b is continuous to the top end (the part closest to the lower surface of the top plate 20) of the upright slot 52a of the “ [symbol] ” shape. And, a part of the score panel 30 that becomes a lower part (the lower part of FIG. 5) when the score panel 30 is configured in an upright position and laid down is movable. Moreover, the guiding-side guide slot 52b is disposed in recess with a width (the length along the up and down direction of FIG. 6(b)) the same as that of the upright slot 52a.

Since the upright slot 52a and the guiding-side guide slot 52b are a continuous recess, the upright slot 52a and the guiding-side guide slot 52b may be fabricated in the same fabrication process. Therefore, the cost of processing the upright slot 52a and the guiding-side guide slot 52b is reduced. Moreover, since the guide member 52 is fixed to the lower surface of the top plate 20, the guiding-side guide slot 52b is located at a position lower than the top plate 20 when the guide member 52 is fixed to the top plate 20.

Moreover, in the guide member 52, the limit wall 52c forms a side surface (a surface of the top side of FIG. 6(b)) opposite to a side surface (a surface of the lower side of FIG. 6(b)) formed in recess with the upright slot 52a and the guiding-side guide slot 52b. Therefore, even if the connection of the supporting member 40 becomes loosed causing the score panel 30 to swing relative to the accommodating member 51, as the shaft-like member 31 leans against the limit wall 52c, the swinging of the score panel 30 relative to the accommodating member 51 can be prevented.

As shown in FIG. 4, in the lay-down state of the score panel 30, a specific gap exists between the front opening surface 21a of the top plate 20 and the long surface 30a at the front side of the score panel 30 opposite to the front opening surface 21a of the top plate 20, and the shaft-like member 31 is located at the front end of the body-side guide slot 22 and the guiding-side guide slot 52b. As the score panel 30 is configured in an upright position, the shaft-like member 31 slides in the body-side guide slot 22 and the guiding-side guide slot 52b, and move backwards (the side of the back surface flange 51b2, the right side of FIG. 4).

As shown in FIG. 5, when the score panel 30 is configured in an upright position, the shaft-like member 31 moves downwards (a lower side of FIG. 5) along the upright slot 52a due to the deadweight of the score panel 30, and is engaged to the lowest part of the upright slot 52a. In this way, the upright state of the score panel 30 is maintained.

As described above, the accommodating member 51 and the guide member 52 are installed at the lower surface of the top plate 20. Therefore, the bottom surface 51a1 of the accommodating member 51 (the part where the other end of the supporting member 40 is rotatably connected to) is disposed at a position lower than the lower surface of the top plate 20. Moreover, the rectangular body-side guide slot 22 is recessed on the lower surface of the top plate 20, and the guiding-side guide slot 52b is recessed on the guide member 52. Therefore, the body-side guide slot 22 and the guiding-side guide slot 52b (a place where a pair of the shaft-like members 31 is supported by the guide member 52) are disposed at a place lower than the upper surface of the top plate 20 by the thickness of the score panel 30. Therefore, when the shaft-like member 31 slides in the body-side guide slot 22 and the guiding-side guide slot 52b to lay down the score panel 30, the score panel 30 is disposed in the opening 21 of the top plate 20 and is aligned to the top plate 20. Therefore, the score panel, in the lay-down state, is aligned to the top plate 20.

Moreover, when the score panel 30 is laid down, the pair of shaft-like members 31 protruding out from two sides of the score panel 30 (which are formed integrally with the score panel 30) are respectively supported by the guide member 52 directly installed on the top plate 20. In this way, a position (especially a configuration position along the up and down direction) at which the score panel 30 is configured relative to the top plate 20 is only defined by the relationship of the score panel 30 and the top plate 20.

Namely, when the score panel 30 is laid down, the pair of shaft-like members 31 sliding in the body-side guide slot 22 and the guiding-side guide slot 52b are supported by the guide member 52 (the guiding-side guide slot 52b) directly connected to the lower surface (the lower surface of FIG. 4) of the top plate 20. Therefore, since the pair of shaft-like members 31 are formed integrally with the score panel 30, the position of the score panel 30 along the up and down direction is determined by a recess depth of the guiding-side guide slot 52b which supports the pair of shaft-like members 31. Specifically, in order to align the score panel 30 and the top plate 20, the recess depth of the guiding-side guide slot 52b is set to match a following situation, i.e. a sum of a plate thickness (a length along the up and down direction) of the top plate 20 (the part of the top plate 20 set with the body-side slot 22 in recess) and the recess depth of the guiding-side guide slot 52b is equal to a sum of the plate thickness of the score panel 30 and a diameter of the pair of shaft-like member 31. Therefore, by setting the depth of the guiding-side guide slot 52b according to the relationship of the score panel 30 and the top plate 20, the configuration position of the score panel 30 relative to the top plate 20 along the up and down direction can be determined, so that the position accuracy of the score panel 30 relative to the top plate 20 along the up and down direction is enhanced.

Moreover, the guide member 52 and the accommodating member 51 are separately formed. Therefore, the guide member 52 is disposed at a place apart from the accommodating member 51 by a specific distance. Therefore, the top plate 20 is used to shield the guide member 52 when the score panel 30 is configured in an upright position, so as to enhance design property of the music stand device 100.

Namely, when the guide member 52 and the accommodating member 51 are formed integrally, the guide member 52 is disposed in the opening 21 of the top plate 20 in a manner that maintenance of the score panel 30 configured with the shaft-like members 31 in protrusion can be performed in case that the integrally formed guide member 52 and the accommodating member 51 are fixed. Therefore, when the opening 21 of the top plate 20 is viewed from the top as the score panel 30 is configured in an upright position, the guide member 52 is easily viewed.

Comparatively, in the invention, since the guide member 52 and the accommodating member 51 are separately formed, it is not necessary to dispose the guide member 52 in the opening 21 of the top plate 20. Therefore, the guide member 52 can be fixed on the top plate 20 apart from the opening 21 of the top plate 20. In this way, when the opening 21 of the top plate 20 is viewed from the top as the score panel 30 is configured in an upright position, since the guide member 52 is covered by the top plate 20, an exposed part of the music stand device 100 is reduced to enhance the design.

Besides, the guide member 52 includes resin, and the body-side guide slot 22 is recessed on the wood-containing top plate 20. Since the wood has a low processing cost compared to that of the resin, by disposing at least a part of the slot on the top plate 20 for sliding the shaft-like member 31, the cost required for processing the body-side guide slot 22 is reduced compared to a situation of processing the whole slot on the guide member 52 for sliding the shaft-like member 31.

Moreover, a specific gap is formed between the front opening surface 21a of the top plate 20 and the long surface 30a at the front side of the score panel 30, so that even if the score panel 30 is laid down while a finger contacts the front opening surface 21a of the top plate 20 or the long surface 30a at the front side of the score panel 30, the finger is prevented from being caught between the front opening surface 21a of the top plate 20 and the long surface 30a at the front side of the score panel 30.

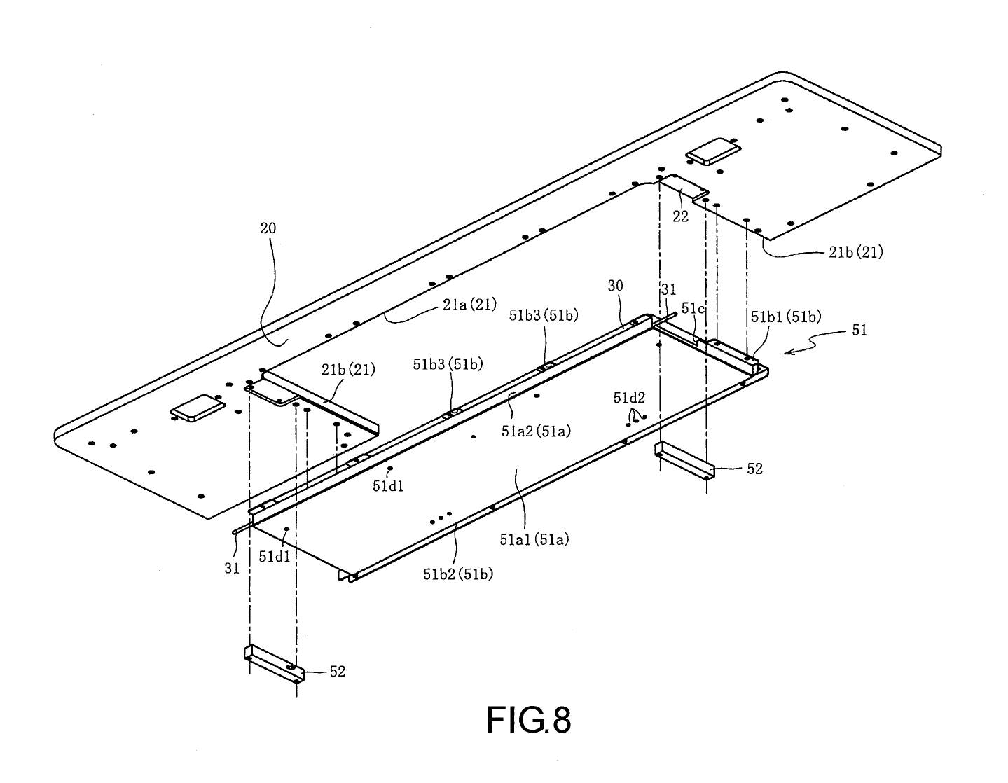

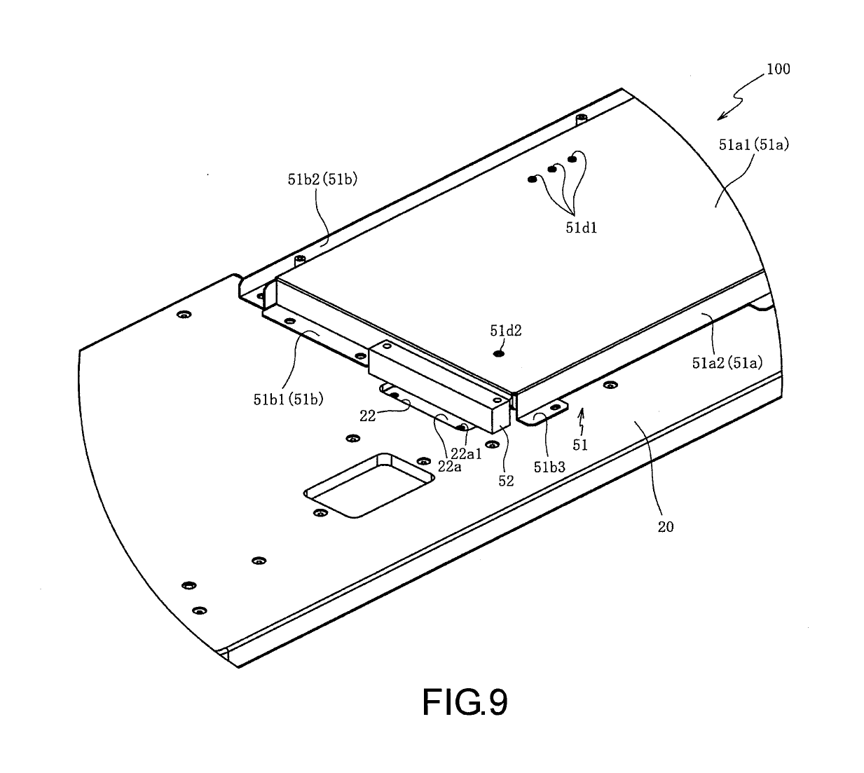

Finally, an assembling process of the music stand device 100 is described with reference to FIG. 7 to FIG. 9. FIG. 7 is an exploded view of the music stand device 100 disassembled into the accommodating member 51, the supporting member 40, the score panel 30 and the score surface end portion 51e. FIG. 8 is an exploded view of the music stand device 100 disassembled into the accommodating member 51, the guide member 52 and the top plate 20. FIG. 9 is a three-dimensional view of the music stand device 100 with the accommodating member 51 and the guide member 52 fixed to the top plate 20. Moreover, in FIG. 9, an illustration of the top plate 20 along the length direction is omitted.

In the present embodiment, not all of the components of the music stand device 100 (the score surface end portion 51e, the supporting member 40, the score panel 30, the accommodating member 51 and the guide member 52) are unitized, but the accommodating member 51, the score surface end portion 51e, the score panel 30 and the supporting member 40 are unitized, and then the unitized accommodating member 51, etc. are fixed to the lower surface of the top plate 20, so that compared to a situation that the components are respectively fixed to the lower surface of the top plate 20, the assembling property of the music stand device 100 can be enhanced. Further details are described below.

As shown in FIG. 7, the score surface end portion 51e is fixed to the bottom surface 51a1 of the body portion 51a of the accommodating member 51. In this way, the upper surface of the score surface end portion 51e is located higher than the bottom surface 51a1 of the body portion 51a by a step. Moreover, one end of the supporting member 40 is rotatably connected to the lower surface (a surface inside the page surface of FIG. 7) of the score panel 30 through the hinge 62, and another end of the supporting member 40 is rotatably connected to the bottom surface 51a1 of the body portion 51a of the accommodating member 51 through the hinge 61. In this way, on the opposite side surfaces (the short surfaces 30b) of the score panel 30, the shaft-like members 31 disposed in protrusion at a position that becomes a lower part of the score panel 30 in case of the upright state of the score panel 30 respectively protrude out from the cut portions 51c of the accommodating member 51, and the score panel 30 is configured in an upright position on and laid down to the accommodating member 51.

As shown in FIG. 8, in the state that the shaft-like members 31 respectively protrude out from the cut portions 51c of the accommodating member 51, the accommodating member 51 that supports the upright and lay-down states of the score panel 30 is fixed to the lower surface of the top plate 20 in a manner of blocking the opening 21 penetrating through the top plate. In this situation, by accommodating the shaft-like members 31 respectively protruding out from the cut portions 51c of the accommodating member 51 in the body-side guide slots 22 of the top plate 20, the positioning of the accommodating member 51 relative to the top plate 20 is achieved.

When the accommodating member 51 is fixed to the lower surface of the top plate 20, the score panel 30 is disposed in the opening 21 of the top plate 20 and is aligned to the top plate 20. Therefore, as long as the accommodating member 51 is fixed to the lower surface of the top plate 20, the score panel 30 is disposed in alignment to the top plate 20, and the shaft-like members 31 is used to position the accommodating member 51 relative to the top plate 20, so as to facilitate the assembly of the music stand device 100.

As shown in FIG. 9, the guide member 52 is fixed to the lower surface of the top plate 20 in a manner of covering the body-side guide slot 22 of the top plate 20. When the guide member 52 is fixed to the lower surface of the top plate 20, the shaft-like member 31 respectively protruding out from the cut portion 51c of the accommodating member 51 is accommodated in the guiding-side guide slot 52b of the guide member 52, so that the shaft-like member 31 is slided in the body-side guide slot 22 and the guiding-side guide slot 52b, and the score panel 30 is configured in an upright position on or laid down to the accommodating member 51. Therefore, the accommodating member 51, the score surface end portion 51e, the score panel 30 and the supporting member 40 are unitized, and the unitized accommodating member 51, etc. are fixed to the lower surface of the top plate 20, and then the guide member 52 is fixed to the lower surface of the top plate 20, so that compared to the situation that the components of the music stand device 100 are respectively fixed to the lower surface of the top plate 20, the assembling of the music stand device 100 is faciliated, and an assembling time is shortened.

The invention is described with reference to the aforementioned embodiments, though the invention is not limited thereto, and it can be deduced that various modifications and variations can be made without departing from the scope or spirit of the invention.

For example, in the aforementioned embodiments, the accommodating member 51 and the guide member 52 are separately formed, though the invention is not limited thereto. In other exemplary embodiments, the accommodating member 51 and the guide member 52 are formed integrally. In this situation, as long as the member integrally formed by the accommodating member 51 and the guide member 52 is fixed to the lower surface of the top plate 20, the assembling of the music stand device 100 is completed to facilitate the assembling of the music stand device 100, and the assembling time is shortened.

In the aforementioned embodiments, the accommodating member 51 is designed to have a box shape, though the invention is not limited thereto. In other exemplary embodiments, the accommodating member 51 is designed to have a plate shape. In this situation, more preferably, a recess portion corresponding to a shape of the supporting member 40 is configured in a downward direction on the bottom surface 51a1 of the accommodating member 51. By rotatably connecting the other end of the supporting member 40 to the recess portion on the bottom surface 51a1 of the accommodating member 51, not only the other end of the supporting member 40 is disposed at a position lower than the lower surface of the top plate 20, but also a lower end (the bottom surface 51a1 of the accommodating member 41) of the score surface leaning against the score panel 30 is disposed at a height approximately the same as that of the lower surface of the top plate 20. Therefore, it is unnecessary to use the score surface end portion 51e to raise the supporting point of the score surface leaning against the score panel 30, so that the score surface end portion 51e can be omitted. In this way, the assembling of the music stand device 100 is facilitated, and the fabrication cost is reduced.

In the aforementioned embodiments, the front opening surface 21a of the top plate 20 is a surface perpendicular to the upper surface and the lower surface of the top plate 20, though the invention is not limited thereto. In other exemplary embodiments, the front opening surface 21a of the top plate 20 is inclined in a manner that a distance between the front opening surface 21a and the long surface 30a at the front side of the score panel 30 is narrowed along a direction from the upper surface to the lower surface of the top plate 20. In this situation, the front opening surface 21a of the top plate 20 is disposed in front of the score panel 30 when viewing from a player side as the score panel is configured in an upright position, so that by inclining the front opening surface 21a of the top plate 20 in a manner that a distance between the front opening surface 21a and the long surface 30a at the front side of the score panel 30 is narrowed along a direction from the upper surface to the lower surface of the top plate 20, the score surface leaning against the score panel 30 is easily viewed.

In the aforementioned embodiments, the body-side guide slot 22 and the guiding-side guide slot 52b are respectively recessed in the top plate 20 and the guide member 52, though the invention is not limited thereto. In other exemplary embodiments, the body-side guide slot 22 and the guiding-side guide slot 52b recessed in any one of the top plate 20 and the guide member 52. In this situation, a processing time can be reduced and the fabrication cost is reduced.

In the aforementioned embodiments, a situation that the shaft-like member 31 slides in the body-side guide slot 22 is described, though the invention is not limited thereto. In other exemplary embodiments, the shaft-like member 31 may include a rotation shaft, so that the shaft-like member 31 may rotate, and may also move in the body-side guide sot 22 and the guiding-side guide slot 52b. In this situation, the score panel 30 is easily configured in an upright position and laid down through the rotation of the shaft-like member 31.

In the aforementioned embodiments, a situation that on the side surfaces of the score panel 30 that are opposite to each other, the shaft-like members 31 respectively protrude out from a position that becomes a lower part of the score panel 30 in the upright state of the score panel 30 is described, though the invention is not limited thereto. In other exemplary embodiments, the shaft-like member 31 is disposed in protrusion on any one of the opposite side surfaces of the score panel 30. In this situation, compared to the aforementioned embodiment, the number of the shaft-like member 31 and the slots (the body-side guide slot 22, the upright slot 52a and the guiding-side guide slot 52b) where the shaft-like member 31 slides on can be reduced, so that the fabrication cost is reduced by reducing the number of parts and the corresponding processing time.

In the aforementioned embodiments, a situation that the accommodating member 51 is installed to the lower surface of the top plate 20 is described, though the invention is not limited thereto. In other exemplary embodiments, the accommodating member 51 may be installed to the upper surface of the top plate 20. For example, the flanges 51b of the accommodating member 51 may be elaborately decorated and installed to the upper surface of the top plate 20. In this way, the design property of the music stand device 100 is enhanced. Moreover, in this situation, more preferably, the depth of the box-shaped accommodating member 51 is set by the plate thickness of the top plate 20.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A music stand device, comprising:
a top plate, having a plate shape;
a score panel, supported by the top plate to configure in an upright position or lay down, and having a plate shape;
a supporting member, having one end rotatably connected to the score panel, and supporting the score panel to be configured in an upright position or laid down on the top plate;
a shaft-like member, protruding at a position that becomes a lower part of the score panel in case of an upright state of the score panel on at least one of opposite side surfaces on the score panel; and
a top plate holding member, having an upright slot and a bottom surface, wherein, the shaft-like member is capable of being engaged with the upright slot due to a deadweight of the score panel when the score panel is configured in an upright position, and another end of the supporting member is rotatably connected to the bottom surface,
wherein, the top plate has an opening penetrating through the top plate,
the top plate holding member is installed to the top plate in a manner of blocking the opening of the top plate, and the bottom surface is disposed at a position lower than an upper surface of the top plate,
at least one of the top plate holding member and the top plate has a guide slot, the upright slot is continuous with the guide slot which is recessed in the top plate holding member or in the top plate, and the guide slot is disposed at a position lower than the upper surface of the top plate, and a part of the score panel that becomes a lower part of the score panel, when the score panel is configured in an upright position and laid down, is movable,
as the shaft-like member moves in the guide slot, the score panel is disposed in the opening of the top plate and is laid down to align with the top plate.

2. The music stand device as claimed in claim 1, wherein,
the top plate holding member comprises:
a guide member, which the upright slot is recessed in the guide member; and
an accommodating member, having the bottom surface and blocking the opening of the top plate,
wherein, the guide member and the accommodating member are formed separately.

3. The music stand device as claimed in claim 1, wherein,
when the score panel is laid down, the top plate holding member supports the shaft-like member, and the score panel is positioned relative to the top plate along an up and down direction.

4. The music stand device as claimed in claim 2, wherein,
when the score panel is laid down, the guide member supports the shaft-like member, and the score panel is positioned relative to the top plate along an up and down direction.

5. The music stand device as claimed in claim 2, wherein,
the guide member comprises resin,
the top plate comprises wood,
at least a part of the guide slot is recessed in the top plate.

6. The music stand device as claimed in claim 1, wherein
the top plate has an opening surface,
the opening surface is an inner side surface of the opening of the top plate, and
in the upright state of the score panel, the opening surface is disposed separately from the score panel, and in a lay-down state of the score panel, the opening surface is disposed close to the score panel,
the score panel has a front surface opposite to the opening surface of the top plate,
in the lay-down state of the score panel, a specific gap is formed between the opening surface of the top plate and the front surface of the score panel.

7. The music stand device as claimed in claim 6, wherein,
the opening surface of the top plate is inclined in a manner that a distance between the opening surface and the front surface of the score panel is narrowed along a direction from the upper surface to the lower surface of the top plate.
